(19) United States
(12) Patent Application Publication
(10) Pub. No.: US 2008/0280256 A1
(43) Pub. Date: Nov. 13, 2008

(54) Receiver for a plug-in connection for fixing crown or jaw segments

(76) Inventor: Robert Laux, Sulzbach/Murr (DE)

Correspondence Address: KLAUS J. BACH & ASSOCIATES, 4407 TWIN OAKS DRIVE, MURRYSVILLE, PA, 15668, US

(21) Appl. No.: 12/218,605

(22) Filed: Jul. 16, 2008

Related U.S. Application Data
(63) Continuation-in-part of application No. PCT/EP2007/000449, filed on Jan. 19, 2007.

(30) Foreign Application Priority Data
Jan. 20, 2006 (DE) 10 2006 003 091.5
Jan. 26, 2006 (DE) 10 2006 003 946.7

(51) Int. Cl. A61C 13/10

(52) U.S. Cl. 433/191

(57) ABSTRACT

In a receiver for a plug-in connection for fixing tooth crown- and jaw segments on a model base, comprising a plug-in sleeve with two plug recesses for accommodating two parallel plug-in shafts of a connector pin. A engagement structure extends between the plug recesses in the plug recesses for engaging the plug-in shafts and is provided with a slot providing for radial flexibility of the engagement structure.

This is a Continuation-in-Part Application of pending International Patent Application PCT/EP2007/000449 filed Jan. 19, 2007 and claiming the priority of German Patent Applications 10 2006 003 091.5 filed Jan. 20, 2006 and 10 2006 003 946.7 filed Jan. 26, 2006.

### BACKGROUND OF THE INVENTION

The invention relates to a receiver for a plug-in connection for fixing tooth crown or jaw segments on a model base wherein a plug-shaft of a connecting pin is removably insertable into a recess of the plug-in connection.

EP 1 028 669 B1 discloses a plug-in connection whereby tooth crown or jaw segments can be connected to a model base. The plug-in connection comprises a connecting pin and a plug receiver sleeve which is firmly integrated into the model base. The connecting pin on the other hand is firmly connected to the tooth crown, or respectively, the jaw segments. For machining the work samples, the connecting pin carrying the segments is inserted into a receiver sleeve which is disposed in the model base. With the connecting pin inserted, the samples are firmly supported on the model base so that they can be precisely machined. By withdrawing the connecting pins, the samples are released and removed but can be returned to the desired machining positions and fixed by re-insertion of the connecting pin into the receiver sleeve whenever desired.

The receiver sleeve has a cylindrical sleeve surface and has a recess which is formed by two axially spaced conical sections. Also, the outer surface area of the connecting pin to be inserted has two corresponding cone-shaped sections which are tightly accommodated in the recess when the connecting pin is inserted into the recess. The cone-shaped spaced sections of the receiver sleeve are joined by way of a cylindrical section which ensures that the shaft of the connecting pin is engaged not over its whole length but only in the area of its conical section in order to reduce friction.

US 2005/0019723 A1 discloses a receiver sleeve for a plug-in connection for fixing tooth crown or jaw segments on a model base wherein the receiver sleeve is adapted to accommodate a double-leg plug-in pin and includes two recesses which extend parallel to each other and into which the two legs of the pin can be inserted. The two recesses in the receiver sleeve are completely separate from each other. The plug-in recesses and the legs of the pin have each a cone-shaped cross-section which has the advantage that a firm connection between the receiver sleeve and the pin can be established. On the other hand, there is the danger that a connection once established can be released again only by applying a substantial force whereby the material can possibly be damaged.

It is the object of the present invention to provide a receiver sleeve for a plug-in connection for fixing tooth crown and jaw segments on a base which has a simple design and is easy to manufacture and which permits the use of a relatively soft and resilient material for the receiver sleeve but which at the same time provides for a secure tight connection with the connecting pin to be inserted.

### SUMMARY OF THE INVENTION

In a receiver for a plug-in connection for fixing tooth crown- and jaw segments on a model base, comprising a plug-in sleeve with two plug recesses for accommodating two parallel plug-in shafts of a connector pin. A engagement structure extends between the plug recesses in the plug recesses for engaging the plug-in shafts and is provided with a slot providing for radial flexibility of the engagement structure.

The receiver sleeve consists of a non-metallic material, expediently of a plastic material, particularly an injection molding plastic material or of a ceramic material or another non-metallic material which is generally softer than metal. The receiver sleeve includes two plug-in recesses which are arranged side-by-side, parallel or angled for accommodating two plug-in shafts of a connecting pin, wherein the plug-in recesses are interconnected via a engagement structure which extends at least over a part of the axial length of the plug-in recesses.

In accordance with a first aspect of the invention, the engagement structure includes a slot-shaped or slot-like gap. It provides for a certain resiliency of the plug-in sleeve in a radial direction, that is, it reduces the rigidity of the plug-in sleeve and permits within certain limits a radial expansion of the plug-in sleeve when the plug-in shafts of the connecting pin are inserted. As a result of such expansion, the inner surface of the recesses adapt to the outer surface of the plug-in shafts when they are inserted into the recesses so that an at least partial areal engagement between the recesses and the plug-in shafts is achieved with result in a firm frictional sleeve, deviations of the dimensions of the sleeve from the desired values occurring during manufacture can be compensated for, which results in high error tolerances. Manufacturing tolerances resulting in somewhat different finished product sizes can be tolerated as, by the capability of the plug-in recesses to expand, their size is automatically adjusted to the size of the shafts being inserted into the sleeves.

Between the recesses, a engagement structure extends in the plug-in sleeve, the engagement structure including a slot which extends between the two plug-in recesses. The engagement structure delimiting the two recesses provides on one hand for a precise guidance of the plug-in shafts during insertion of the connecting pin since each recess has a wall which extends for almost 360° and is only interrupted in the area of the small slot. On the other hand, the slot between the engagement structures provides for a minimum resiliency and facilitates the radial expansion of the sleeve. The engagement structure is in this includes a slot-shaped recess in the engagement structure extending between the two plug-in recesses and may have various thicknesses. For example, the slot can be provided only in the form of a separation of the engagement structures so that it can become wider under load but that the engagement structure halves facing each other abut each other when they are not biased apart. In another embodiment, the slot may form a gap of such a width that the web halves are spaced from each other also when they are not biased apart. Also in this case, the plug-in shafts are enclosed by the recesses in circumferential direction by an angle which is greater than 180°.

In accordance with another aspect of the invention, cam or web-like projections are provided on the inner wall of the plug-in sleeve which are preferably line-like elongated and which may extend particularly axially over a section of the plug-in sleeve. The outer surface of the plugged-in connecting pins abuts those cam-like projections so that, at least in the area of the projections, an areal contact between the inner surface of the plug-in sleeve and the outer surface of the connecting pin and, consequently, a high friction is avoided. This contact at the cam-like projections is also maintained with a small deformation of the plug-in sleeve during insertion of the connecting pin. If the projections have the shape of elongated bodies, a line-like contact is provided whereas, with circular or point-like projections, a point contact is established. However, for improved guidance and stability, a line-like contact with cam-like elongated projections which extend in the axial direction of the plug-in sleeve is preferred. As connecting section between the plug-in recesses, a slot-shaped or slot-like recess providing for a gap may be considered as well as an embodiment in the form of a solid bridge or similar structure which forms a firm connection between the two plug-in recesses.

In accordance with another advantageous embodiment, the plug-in sleeve may be divided into two different axial sections: A socket receiver provided adjacent the recess in the upper part of the plug-in sleeve for the reception of a pin socket of the connecting pin which interconnects the two plug-in shafts, and also the two plug-in recesses which are disposed axially adjacent the socket-accommodating structure into which the two plug-in shafts of the connecting pin are inserted. The engagement structure extends only between the recesses; the cam-like projections are, in accordance with a preferred embodiment, arranged only at the inner surface of the socket accommodation structure. The connecting pin inserted into the plug-in sleeve extends with its two plug-in shafts into the recesses whereby an areal contact between the outer surface of the plug-in shafts and the inner surface of the recesses is established.

Depending on the conditions, the areal contact is limited to axial partial areas of the recesses or it is completely eliminated. The pin socket of the connecting pin is then disposed in socket accommodating structure in the plug-in sleeve; the outer surface of the pin socket only has a line-like—possibly, point-like—contact area with the cam-like projections on the inner surface of the socket accommodation structure in the plug-in sleeve. At the same time then, contact points are provided at the front end at additional cam-like projections.

It may be expedient to provide the engagement structure, which extends in axial direction between the two recesses, at the front end thereof opposite the plug-in recess of the plug-in sleeve with a bridge member so that the engagement structure is closed at the front end. The slot formed into the engagement structure extends in this embodiment not completely to the front end of the engagement structure sleeve and consequently extends in an axial direction only over part of the length of the web. The bridge member interconnecting the two engagement structure halves in the area of the lower axial front end of the plug-in sleeve on one hand improves the stability and, on the other hand, prevents an undesired ingression of material of the model base, generally plaster, into the interior of the sleeve. Since however, at the same time, the slot also extends over a large part of the axial length of the web, the advantage that the plug-in sleeve can be radially expanded upon insertion of the connecting pin remains.

In accordance with another embodiment of the invention, the cam-like projections may not only be in the areas of the socket accommodation structure but also at least in parts of the recesses. In accordance with an alternative embodiment the cam-like projections may also be provided exclusively on the recess surfaces and not on the socket accommodation structure.

The outer surface area of the plug-in sleeve is expediently provided with a groove extending over the axial length thereof, whereby the wall thickness of the plug-in sleeve is reduced and the stretch capability in radial direction is improved.

The two plug-in recesses in the plug-in sleeve are preferably cone-shaped and, in particular, have different cone diameters whereby the plug-in position is clearly determined. Cylindrical plug-in shafts and plug-in recesses or a combination of conical and cylindrical sections may also be used.

The invention will become more readily apparent from the following description of exemplary embodiments thereof on the basis of the accompanying drawings.

### BRIEF DESCRIPTION OF THE DRAWINGS

FIG. 1 is a side view of a connecting pin which is used for establishing a plug-in connection with a plug-in sleeve wherein, by way of the plug-in connection, a tooth crown or a jaw segment are fixed to a model base,

FIG. 2 is a side view of the connecting pin,

FIG. 3 is a top view of the connecting pin,

FIG. 4 shows the connecting pin in a perspective view,

FIG. 5 shows a side view of a plug-in sleeve with the connecting pin inserted,

FIG. 6 shows the plug-in sleeve and the connecting pin in another side view,

FIG. 7 is a top view of the plug-in sleeve and connecting pin,

FIG. 8 is a top view of the plug-in sleeve without the connecting pin and,

FIG. 9 is a longitudinal cross-sectional view of the connecting sleeve.

### DESCRIPTION OF A PARTICULAR EMBODIMENT

In the various figures, the same reference numerals are used for the designation of identical components.

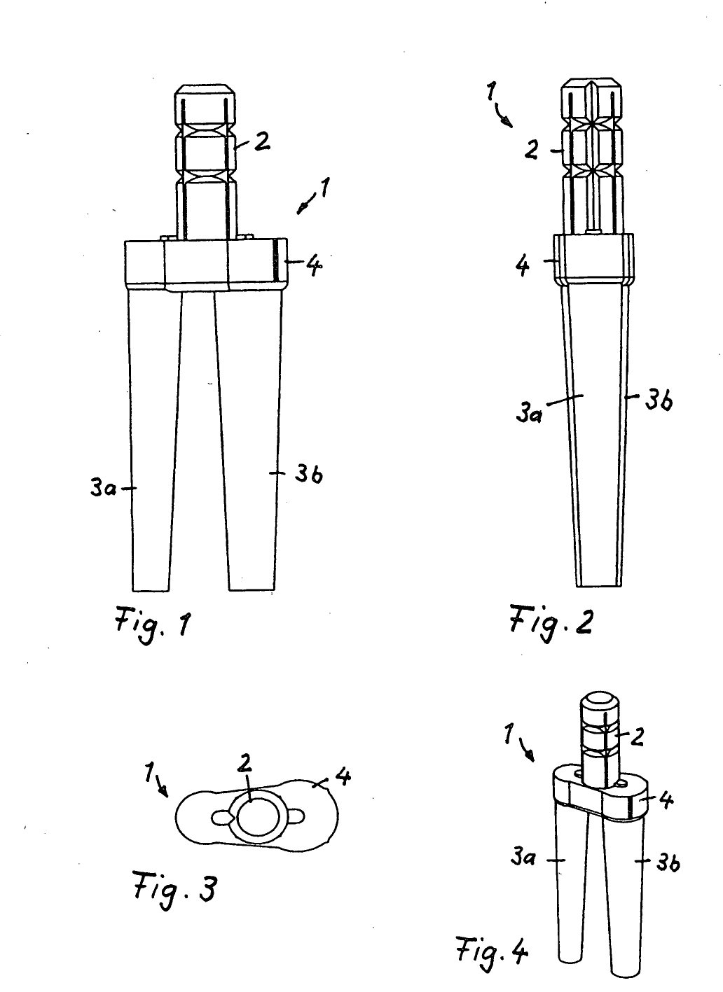

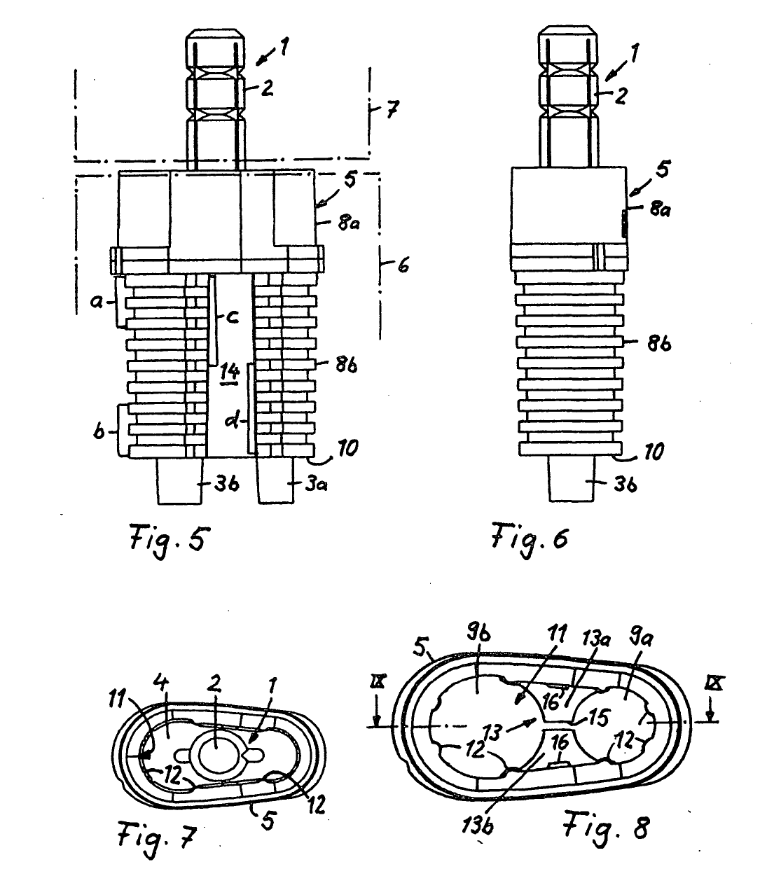

The connecting pin 1 as shown in FIGS. 1-4 is used for plug-in connections for fixing tooth crown- or jaw segments of plaster or similar materials onto a model base, which, generally, also consists of plaster. The connecting pin 1 cooperates in the plug-in connection with a plug-in sleeve 5 as it is shown in FIGS. 5-7. The upper part of the connecting pin 1 is in the form of a cylindrical fixing shaft 2, which is inserted into a pre-finished bore of the tooth crown or jaw segment and firmly joined thereto for example by cementing. The lower part of the connecting pin 1 comprises two plug-in shafts 3a and 3b which are each cone-shaped but which have different diameters. In the embodiment shown, the largest diameter of the smaller plug-in shaft 3a is smaller than the largest diameter of the larger plug-in shaft 3b. In accordance therewith also the smallest diameter at the front end of the plug-in shaft 3a is smaller than the smallest diameter at the front end of the larger plug-in shaft 3b. Preferably, both plug-in shafts 3a, 3b have the same conicity.

The fixing shaft 2 is mounted onto a pin socket 4 which is disc-shaped and which carries, at its end opposite the fixing shaft 2, the two plug-in shafts 3a, 3b. The fixing shaft 2 includes circumferential indents which facilitate the connection of the fixing shaft 2 with the tooth crown or, respectively, the jaw segment. Expediently, the connecting pin 1 consists of a metallic material.

As particularly apparent from the top view of FIG. 3 and the perspective view of FIG. 4, the configuration of the pin socket 4 is adapted to the diameters of the differently sized plug-in shafts 3a and 3b. The diameter of the upwardly projecting fixing shaft 2 is approximately as large as the diameter of the smaller plug-in shaft 3a.

The FIGS. 5 to 7 show the plug-in connection with a connecting pin inserted into a plug-in sleeve 5. The plug-in sleeve 5 is firmly integrated into a model base 6 which consists for example of plaster and which carries the tooth crown or jaw segment 7, into which the fixing shaft 2 of the connecting pin 1 is firmly embedded. By way of the plug-in connection of the connecting pin 1 and the plug-in sleeve 5, the tooth crown or jaw segment 7 can be releasably connected to the model base 6.

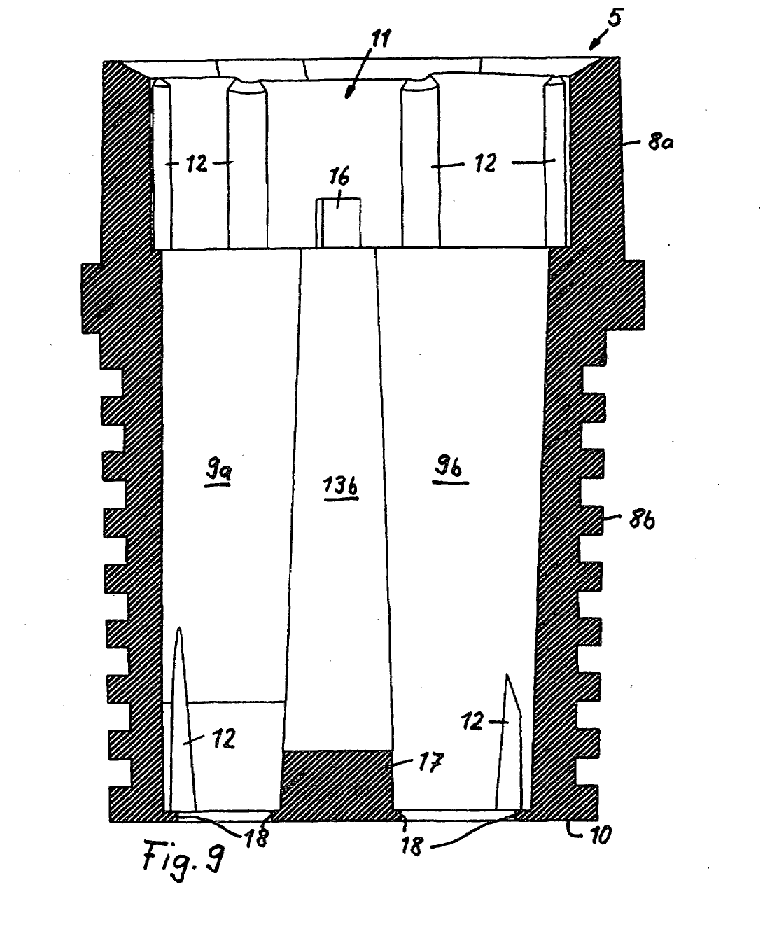

The plug-in sleeve 5 includes an upper section 8a, which comprises a socket accommodation structure for the pin socket of the connecting pin 1 and a lower section 8b into which two plug recesses 9a, 9b are formed which are disposed beside one another (FIG. 8) and into which the two plug-in shafts 3a and 3b of the connecting pin are to be inserted. The two plug-in recesses 9a, 9b extend parallel to one another but they could also be arranged at angles relative to one another. The plug-in shafts 3a and 3b extend accordingly in parallel relationship or, respectively, at an angle.

The plug-in shafts 3a and 3b project from the bottom side 10 of the plug-in sleeve 5. Between the outer surface of the plug-in shafts 3a and 3b and the inner surface of the recesses 9a, 9b, there is a contact area which may extend over the full axial length or only over part of the axial length of the plug-in recesses 9a, 9b. The contact area may also be formed by the cone-shaped projections. As apparent from FIG. 5, the contact area may be limited to parts of the axial areas a and b which are spaced from each other, whereas no contact is established in the section between the axial areas a and b. in the exemplary embodiment, the partial areas a and be in which a contact is established are located in the upper and the lower sections of the recesses 9a, 9b, but in accordance with an alternative embodiment contact may also be provided only in the intermediate area while in the upper and lower areas a, b any areal contact is avoided. Furthermore, contact areas may also be recesses, for example, in an upper partial area c of the first recess and in a lower partial area of the second recess.

The outer surface of the lower section 8b of the plug-in sleeve 5, which receives the plug-in shafts of the connecting pin 1, is provided with transverse grooves which provide for an improved anchoring of the plug-in sleeve 1 in the model base 6. The upper section 8a of the plug-in sleeve 5 has a diameter which remains constant in axial direction while the lower section 8b is slightly tapered.

In the top view of FIGS. 7 and 8—FIG. 7 is a top view of the plug-in connection with the plug-in sleeve 5 and the connecting pin 1 and FIG. 8 is an enclosed top view of the plug-in connection without the connecting pin 1—the socket accommodation structure 11 in the plug-in sleeve 5 is shown—in which the pin socket 4 of the connecting pin 1 is received. The contour of the socket accommodation structure 11 is adapted to the contour of the pin socket 4, but the inner surface of the socket accommodation structure 11 is provided with at least two or preferably eight or more cam-like projections 12, which extend into the plug recesses 9a or, respectively, 9b and which are engaged by the smooth surface of the pin socket 4. The cam-like projections are elongated and extend in axial direction as apparent particularly from FIG. 9. In this way, a line-contact is established between each cam-like projection and the adjacent surface which is in contact with the pin socket 4. The cam-like projections 12 are disposed exclusively in the socket accommodation structure 11 of the plug-in sleeve 5, but not in the recesses 9a and 9b. In another embodiment, it may be expedient to provide such cam-like projections also in the plug-in recesses, particularly at the front end of the sleeve, possibly additionally to those provided in the socket accommodation structure or even exclusively in the accommodation structure.

As shown in FIG. 5, the outer circumferential surface of the plug-in sleeve 5 includes an axially extending opening 14. The axial opening 14 is disposed at a level of a engagement structure 13 which extends axially over the length of the lower sections 8b in the plug-in sleeve 5 and reduces the wall thickness of the plug-in sleeve 5. The axial opening 14 is arranged adjacent the engagement structure 13 and extends between the two recesses 9a and 9b. As apparent in particular from the top view of FIG. 8, the engagement structure 13 includes two sections 13a, 13b which form each part of the wall of the plug-in sleeve 5 and which are separated from each other by a gap 15. The engagement structure sections 13a and 13b complement the inner surfaces of the recesses 9a and 9b to form an envelope extending almost over 360° interrupted only by the small slot 15. Because of that small slot 15, the plug-in sleeve 5 is expandable to a certain degree in radial direction, that is, in both transverse radial direction with respect to the longitudinal axis of the plug-in sleeve. Because of this radial flexibility, manufacturing tolerances, which can occur during the manufacture of the plug-in sleeve that is manufactured by plastic material injection molding, can be compensated.

As further apparent from FIGS. 8 and 9, the socket accommodation structure 11 is disposed immediately above the engagement structure 13, which extends axially only over the length of the recesses 9a and 9b and a delimiting stop 16 is provided at a level below the upper section 8a of the plug-in sleeve 5 and which limits the insertion depth of the connecting pin 1. The pin socket 4 of the connecting pin 1 is seated on this stop 16.

As shown in FIG. 9, the two sections of the engagement structure 13 are interconnected in the area of the lower front end 10 of the plug-in sleeve by a bridge 17. In this area, the two engagement structure sections are therefore not separated by the gap 15. The bridge 17 on one hand improves the stability of the plug-in sleeve and, on the other hand, it prevents an undesired influx of plaster when the plug-in sleeve is inserted into a bore of the model base provided herefor.

At the lower front end 10 of the plug-in sleeve 5, the openings or respectively, bores for the plug-in recesses 9a, 9b are delimited by small projections 18 which reduce the lower diameter. These projections which reduce the diameter provide for a safe guidance for the plug-in shafts 3a and 3b of the connecting pin 1 upon their insertion into the recesses 9a and 9b and provide for further sealing to prevent plaster from entering.

What is claimed is:

1. A receiver for a plug-in connection for fixing tooth crown- or jaw segments on a model base, comprising a plug-in sleeve (5) having a plug-in recess (9a, 9b), a connecting pin 1 with a plug-in shaft (3a, 3b) releasably insertable into the plug-in recess (9a, 9b), the plug-in sleeve (5) consisting of a non-metallic material and having two recesses (9a, 9b) for the reception of the two plug-in shafts (3a, 3b), a engagement structure (13) extending between the recesses (9a, 9b), the engagement structure (13) having engagement sections which are separated by a gap (15) that extends between the two plug recesses (9a, 9b) and at least over part of the axial length of the plug-in recesses (9a, 9b).

2. The receiver according to claim 1, wherein the plug-in sleeve (5) consists of plastic material and is formed by injection molding.

3. The receiver according to claim 1, wherein the slot (15) extends axially only over part of the length of the engagement structure (13).

4. The receiver according to claim 3, wherein the engagement structure (13) extends in the area adjacent a front end (10) of the plug-in sleeve (5) continuously across the plug-in sleeve (5).

5. The receiver according to claim 1, wherein an outer surface area of the plug-in sleeve (5) is provided with a groove (14) extending over the length of the plug-in sleeve (5) (13) for reducing the wall thickness.

6. The receiver according to claim 1, wherein the two recesses (9a, 9b) are provided in the upper part of the plug-in sleeve (5) with a socket accommodation structure (11) which receives a pin socket (4) of the connecting pin (1) that extends between, and interconnects, the two plug-in shafts (3a, 3b).

7. The receiver according to claim 1, wherein the connecting member (13) extends axially over the length of the plug-in recesses (9a, 9b) and the front end (10) of the connecting member (13) facing the socket accommodation structure (11), and a stop (16) is provided for limiting the insertion depth of the connecting pin (1).

8. The receiver according to claim 1, wherein the two plug recesses (9a, 9b) are conically tapered.

9. The receiver according to claim 8, wherein the plug recesses (9a, 9b) have different cone diameters.

10. The receiver according to claim 1, wherein the plug-in sleeve is provided at its outer contour with circumferential grooves.

11. The receiver according to claim 1, wherein the slot (15) has a width of at least 1 mm.

12. A receiver for a plug-in connection for fixing tooth crown or jaw segments on a model base, comprising a plug-in sleeve (5) having plug recesses (9a, 9b) for releasable accommodating plug-in shafts (3a, 3b) of a connecting pin (1), said plug-in sleeve (5) consisting of a non-metallic material and including two plug recesses (9a, 9b) for accommodating the plug-in shafts (3a, 3b) which extend in parallel relationship, said plug recesses (9a, 9b) being provided with a engagement structure which extends between the plug recesses (9a, 9b) at least over part of the axial length of the plug recesses (9a, 9b) and the plug-in sleeve (5) having an inner wall provided with cam-like projections (12) for engaging the plug-in shafts (3a, 3b) when inserted into the plug recesses (9a, 9b).

13. The plug-in sleeve according to claim 12, wherein the cam-like projections (12) extend axially at least over part of the length of the plug-in sleeve (2).

14. The plug-in sleeve according to claim 13, wherein the plug-in shafts (3a, 3b) have a socket (4) and the plug-in sleeve (5) includes a socket accommodation structure (11), and the cam-like projections (12) are provided on the interior wall of only one of the socket accommodation structures (11) which received one pin socket (4) of the connecting pin (1) interconnecting the two plug-in shafts (3a, 3b).

15. The plug-in sleeve according to claim 13, wherein the cam-like projections (12) are provided only on the inner wall of the plug recesses (9a, 9b).

16. The plug-in sleeve according to claim 15, wherein the cam-like projections (12) extend up to the front end of the play recesses (9a, 9b).
